(19) United States
(12) Patent Application Publication
(10) Pub. No.: US 2024/0358157 A1
(43) Pub. Date: Oct. 31, 2024

(54) Chair

(71) Applicant: Xuanbin Yang, Jiangsu Province (CN)

(72) Inventor: Xuanbin Yang, Jiangsu Province (CN)

(21) Appl. No.: 18/198,331

(22) Filed: May 17, 2023

(30) Foreign Application Priority Data
Apr. 26, 2023 (CN) 202320986390.9

(51) Int. Cl. A47C 4/03; A47C 5/10

(52) U.S. Cl. CPC A47C 4/03; A47C 5/10

(57) ABSTRACT

The present disclosure provides a chair, including a seat, a leg and a backrest, wherein a plurality of legs are connected to a lower surface of the seat, the seat has a first threaded hole opened thereon, the backrest has a second threaded hole opened thereon, a threaded fastener can be screwed into the first threaded hole and the second threaded hole in sequence, and when the threaded fastener is tightened, a tail end of the threaded fastener is completely located within the second threaded hole. The backrest and the seat are in detachable connection through a threaded fastener, they can be detached during transportation, reducing packaging cost and transportation cost; when the threaded fastener connecting the backrest and the seat is tightened, the tail end of the threaded fastener is completely located within the second threaded hole, making the connection position more aesthetic and reducing potential safety hazard.

### CROSS REFERENCE TO THE RELATED APPLICATION

This application takes the benefit of and claims priority of Chinese Patent Application No 202320986390.9 filed on Apr. 26, 2023, the contents of which are herein incorporated by reference.

### TECHNICAL FIELD

The present disclosure relates to the technical field of articles for daily use, more particular to a chair.

### BACKGROUND

Chair, as a common article for daily use, mainly includes a seat, a leg and a backrest. In existing technologies, chairs generally have the backrests and the seats connected through welding or threaded connectors. The welded chair cannot be disassembled, leading to big packaging volume, high packaging cost and high transportation cost; the chair connected employing threaded connectors often have the tail end of the threaded connector exposed outside, which is not aesthetic and could cause hurt to children getting underneath the chair.

### SUMMARY

The embodiments of the present disclosure provide a chair, to address the problem in existing technologies that a threaded connector is exposed to lead to inaesthetic connection and potential safety hazard when the backrest and the seat of the chair are connected through the threaded connector.

In the embodiments of the present disclosure, the chair includes a seat, a leg and a backrest, wherein a plurality of legs are connected to a lower surface of the seat, the seat has a first threaded hole opened thereon, the backrest has a second threaded hole opened thereon, a threaded fastener can be screwed into the first threaded hole and the second threaded hole in sequence, and when the threaded fastener is tightened, a tail end of the threaded fastener is completely located within the second threaded hole.

In a preferred embodiment of the chair, the backrest includes a plurality of support members arranged at intervals, the support members are used for supporting the back of a user, and the second threaded hole is opened on the support member.

In a preferred embodiment of the chair, the backrest further includes an upper connection plate and a lower connection plate, the upper connection plate is fixedly connected to upper ends of the plurality of support members, and the lower connection plate is fixedly connected to lower ends of the plurality of support members.

In a preferred embodiment of the chair, the support member is arranged as a cylindrical rod, the cylindrical rod is of a hollow structure and the second threaded hole is formed inside the hollow structure.

In a preferred embodiment of the chair, the lower connection plate is connected to a cylindrical surface of the cylindrical rod, and the second threaded hole runs through the lower connection plate.

In a preferred embodiment of the chair, the lower surface of the seat protrudes downward to form a connection portion, and the leg is connected to the seat through the connection portion.

In a preferred embodiment of the chair, the leg has an upper end face fixedly connected to a connection plate, both the connection plate and the connection portion have a mounting hole opened thereon, and a threaded fastener can be screwed into the mounting hole to connect the leg to the seat.

In a preferred embodiment of the chair, a side surface of the seat extends downward to form a circumferential edge, and the circumferential edge has a height greater than or equal to that of the connection portion.

In a preferred embodiment of the chair, a reinforcing member is connected between the legs, and the reinforcing member is used for improving the stability of the legs.

In a preferred embodiment of the chair, the seat, the leg and the backrest are all made of a metallic material.

The embodiments of the present disclosure have the following beneficial effects.

According to the chair provided by the present disclosure, the backrest and the seat are in detachable connection through a threaded fastener, they can be detached during transportation, reducing packaging cost and transportation cost; when the threaded fastener connecting the backrest and the seat is tightened, the tail end of the threaded fastener is completely located within the second threaded hole, making the connection position more aesthetic and reducing potential safety hazard.

### BRIEF DESCRIPTION OF THE DRAWINGS

For a better understanding of the technical scheme in the embodiments of the present disclosure or in the prior art, accompanying drawings needed in the description of the embodiments or the prior art are simply illustrated below. Obviously, the accompanying drawings described below are just some embodiments of the present disclosure. For the ordinary skill in the field, other accompanying drawings may be obtained according to these accompanying drawings without creative work.

In the drawings:

FIG. 1 is an overall structure diagram of a chair according to one embodiment of the present disclosure from one perspective.

FIG. 2 is an overall structure diagram of a chair according to one embodiment of the present disclosure from another perspective.

FIG. 3 is a structure diagram of a backrest according to one embodiment of the present disclosure.

FIG. 4 is a diagram of a connection structure between a backrest and a seat according to one embodiment of the present disclosure.

FIG. 5 is a structure diagram of a leg according to one embodiment of the present disclosure.

### DESCRIPTION OF DESIGNATORS OF MAIN ELEMENTS IN THE DRAWINGS

10, a seat; 11, a connection portion; 12, a circumferential edge, 13, a first threaded hole; 20, a leg; 21, a connection plate; 211, a mounting hole; 22, a reinforcing member; 30, a backrest; 31, a support member; 311, a second threaded hole; 32, an upper connection plate; and 33, a lower connection plate.

### DETAILED DESCRIPTION OF THE EMBODIMENTS

The present disclosure will become more clearly understood from the comprehensive description of the present disclosure below taken in conjunction with relevant accompanying drawings. In the drawings preferable embodiments are given. However, the present disclosure may be implemented through many other different forms and is not limited to the embodiments described in this paper. On the contrary, these embodiments are provided with the purpose of making the content of the present disclosure understood more thoroughly and comprehensively.

It is to be noted that when an element is described as “fixed on” another element, it may be directly on the another element, or there might be an intermediate element between them. When one element is described as “connected to” another element, it may be directly connected to the another element, or there might be an intermediate element between them. Terms “vertical”, “horizontal”, “left”, “right” and similar expressions used in this paper are merely for the purpose of illustration.

Unless otherwise defined, all technical and scientific terms used in this paper have the same meaning as those normally understood by the skill in the technical field of the present disclosure. The terms used in this specification of the present disclosure are just for describing specific embodiments, not to limit the present disclosure. Terms “and/or” used in the present disclosure include any and all combinations of one or more listed items.

The embodiments of the present disclosure provide a chair, to address the problem in existing technologies that a threaded connector is exposed to lead to inaesthetic connection and potential safety hazard when the backrest and the seat of the chair are connected through the threaded connector.

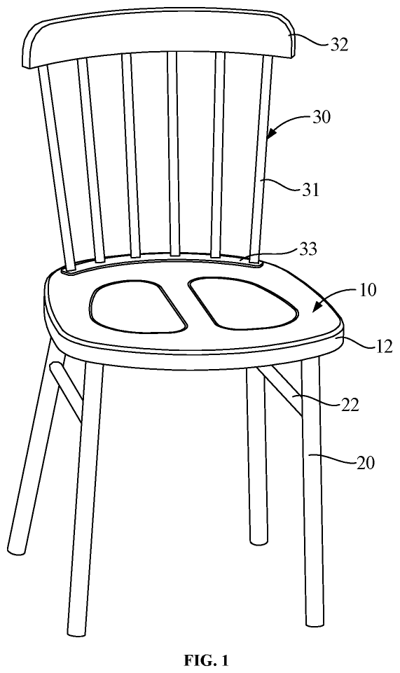

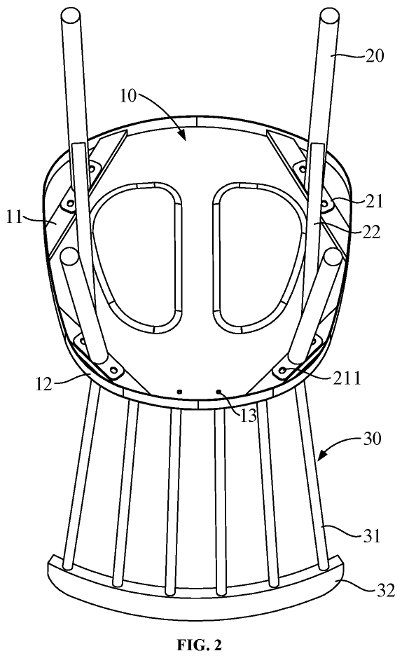

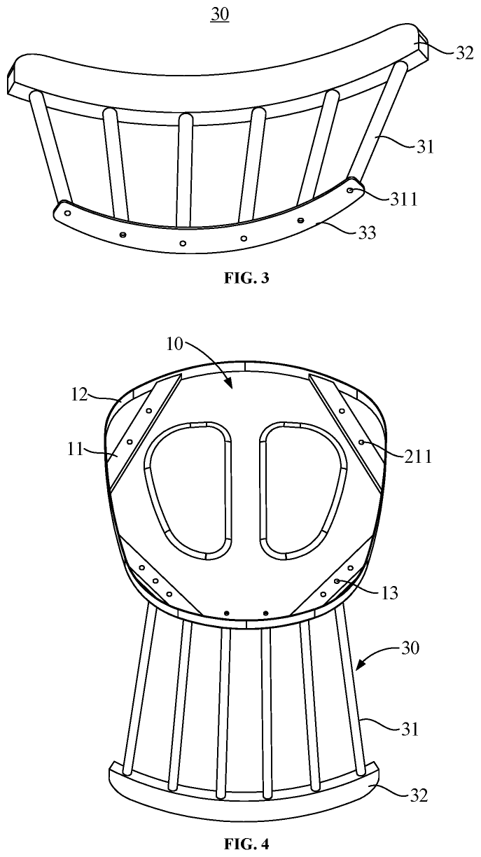

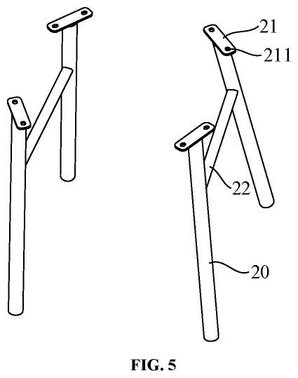

In the embodiments of the present disclosure, refer to FIG. 1 to FIG. 5, the chair includes a seat 10, a leg 20 and a backrest 30, wherein a plurality of legs 20 are connected to a lower surface of the seat 10, the seat 10 has a first threaded hole 13 opened thereon, the backrest 30 has a second threaded hole 311 opened thereon, a threaded fastener can be screwed into the first threaded hole 13 and the second threaded hole 311 in sequence, and when the threaded fastener is tightened, a tail end of the threaded fastener is completely located within the second threaded hole 311.

According to the chair provided by the embodiments of the present disclosure, the backrest 30 and the seat 10 are in detachable connection through a threaded fastener, they can be detached during transportation, reducing packaging cost and transportation cost; when the threaded fastener connecting the backrest 30 and the seat 10 is tightened, the tail end of the threaded fastener is completely located within the second threaded hole 311, making the connection position more aesthetic and reducing potential safety hazard.

In one embodiment, the backrest 30 includes a plurality of support members 31 arranged at intervals, the support members 31 are used for supporting the back of a user, and the second threaded hole 311 is opened on the support member 31.

In a specific embodiment, the backrest 30 further includes an upper connection plate 32 and a lower connection plate 33, the upper connection plate 32 is fixedly connected to upper ends of the plurality of support members 31, and the lower connection plate 33 is fixedly connected to lower ends of the plurality of support members 31.

The arrangement of the upper connection plate 32 and the lower connection plate 33 has the advantage that the upper connection plate 32 and the lower connection plate 33 together with the support members 31 may form the backrest 30, so that the backrest 30 is formed as a separate part, reducing the mounting steps of the user.

For the connection mode between the upper connection plate 32, the support members 31 and the lower connection plate 33, in a more specific embodiment, the upper connection plate 32 and the support members 31 are fixed by welding, the lower connection plate 33 and the support members 31 are fixed by welding too.

In a more specific embodiment, the upper connection plate 32 and the lower connection plate 33 are bent into an arc shape fitting the back of human being.

In a more specific embodiment, the support member 31 is arranged as a cylindrical rod, the cylindrical rod is of a hollow structure and the second threaded hole 311 is formed inside the hollow structure.

In a further specific embodiment, the lower connection plate 33 is connected to a cylindrical surface of the cylindrical rod, and the second threaded hole 311 runs through the lower connection plate 33.

In one embodiment, the lower surface of the seat 10 protrudes downward to form a connection portion 11, and the leg 20 is connected to the seat 10 through the connection portion 11.

In a specific embodiment, the leg 20 has an upper end face fixedly connected to a connection plate 21, both the connection plate 21 and the connection portion 11 have a mounting hole 211 opened thereon, and a threaded fastener can be screwed into the mounting hole 211 to connect the leg 20 to the seat 10.

In this embodiment, several of the first threaded holes 13 are formed on the connection portion 11, when the connection plate 21 is connected to the connection portion 11, the connection plate 21 may shield the threaded fastener on the connection portion 11 that is used for connecting the seat 10 and the backrest 30, further improving the aesthetic degree.

This embodiment has the advantage that the leg 20 and the seat 10 can also be detached, so that the chair can be disassembled into the seat 10, the leg 20 and the backrest 30 before the transportation, improving the modularization degree of the whole product, easing transportation, maintenance and replacement.

In a more specific embodiment, a side surface of the seat 10 extends downward to form a circumferential edge 12, and the circumferential edge 12 has a height greater than or equal to that of the connection portion 11.

The circumferential edge 12 is arranged with the purpose of shielding the connection portion 11 in the usual usage state, improving the aesthetic degree of the product.

In one embodiment, a reinforcing member 22 is connected between the legs 20, and the reinforcing member 22 is used for improving the stability of the legs.

In a specific embodiment, the reinforcing member 22 is connected between the legs 20 in a manner of being parallel to the horizontal plane. Of course, the reinforcing member 22 may also form certain angle with the horizontal plane. It is to be noted that the reinforcing member 22 between two legs 20 may be one or more in quantity. The reinforcing member 22 and the leg 20 may be connected employing a threaded fastener or be fixedly connected by welding.

In one embodiment, the seat 10, the leg 20 and the backrest 30 are all made of a metallic material.

The employment of the metallic material has the advantage that it has higher structural strength and is more suitable for outdoor environment. To avoid the corrosion of the metallic material by outdoor moisture, during manufacturing processes alloy materials with higher corrosion resistance may be employed, or the outer surface of the metallic materials is coated with oil paint or plastic to improve the corrosion resistance.

Each technical feature of the above embodiments may be combined arbitrarily; for concise description, all possible combinations of each technical feature of the above embodiments are not described; however, only if the combination of these technical features has no conflict, it shall be considered to be included in the scope of the description

The above embodiments just illustrate several implementations of the present disclosure, what are described in the above embodiments are specific and detailed, however, they cannot be understood as a limit to the scope of the patent application. It should be noted that, for the ordinal skill in the art, umpty variations and improvements may be made without departing from the thought of the present disclosure, and these shall be included in the scope of protection of the present disclosure. The scope of patent protection of the present disclosure shall depend on the claims appended hereinafter.

What is claimed is:

1. A chair, comprising a seat, a leg and a backrest, wherein a plurality of legs are connected to a lower surface of the seat, the seat has a first threaded hole opened thereon, the backrest has a second threaded hole opened thereon, a threaded fastener can be screwed into the first threaded hole and the second threaded hole in sequence, and when the threaded fastener is tightened, a tail end of the threaded fastener is completely located within the second threaded hole.

2. The chair according to claim 1, wherein the backrest comprises a plurality of support members arranged at intervals, the support members are used for supporting the back of a user, and the second threaded hole is opened on the support member.

3. The chair according to claim 2, wherein the backrest further comprises an upper connection plate and a lower connection plate, the upper connection plate is fixedly connected to upper ends of the plurality of support members, and the lower connection plate is fixedly connected to lower ends of the plurality of support members.

4. The chair according to claim 3, wherein the support member is arranged as a cylindrical rod, the cylindrical rod is of a hollow structure and the second threaded hole is formed inside the hollow structure.

5. The chair according to claim 4, wherein the lower connection plate is connected to a cylindrical surface of the cylindrical rod, and the second threaded hole runs through the lower connection plate.

6. The chair according to claim 1, wherein the lower surface of the seat protrudes downward to form a connection portion, and the leg is connected to the seat through the connection portion.

7. The chair according to claim 6, wherein the leg has an upper end face fixedly connected to a connection plate, both the connection plate and the connection portion have a mounting hole opened thereon, and a threaded fastener can be screwed into the mounting hole to connect the leg to the seat.

8. The chair according to claim 7, wherein a side surface of the seat extends downward to form a circumferential edge, and the circumferential edge has a height greater than or equal to that of the connection portion.

9. The chair according to claim 1, wherein a reinforcing member is connected between the legs, and the reinforcing member is used for improving the stability of the legs.

10. The chair according to claim 1, wherein the seat, the leg and the backrest are all made of a metallic material.
